(19) United States
(12) Patent Application Publication
(10) Pub. No.: US 2007/0085703 A1
(43) Pub. Date: Apr. 19, 2007

(54) Traffic crossing warning device, and method for warning of an oncoming locomotive object

(75) Inventors: Jeffrey W. Clark, Jackson, TN (US); Brent P. Thorley, Fountain Hills, AZ (US)

Correspondence Address: PETER L. BREWER BEARMAN, CALDWELL, & BERKOWITZ;LAW FIRM, 165 MADISON AVENUE, SUITE 2000, MEMPHIS, TN, 38103, US

(73) Assignee: Jeffrey W. Clark

(21) Appl. No.: 11/371,140

(22) Filed: Mar. 8, 2006

Related U.S. Application Data
(60) Provisional application No. 60/727,724, filed on Oct. 18, 2005.

(51) Int. Cl. G08G 1/095; B61L 5/12

(52) U.S. Cl. 340/907; 246/473 R

(57) ABSTRACT

A traffic crossing warning device is provided. The device includes a beam transmitter for transmitting a beam such as an IR beam, and a beam sensor in electrical communication with a signal processor for sensing the IR beam. In addition, the device includes a multimedia warning beacon, and a mounting device for supporting the beacon adjacent a roadway intersection. The warning beacon is activated when the beam sensor senses that the beam is not being received for a predetermined period of time. In one aspect, the warning beacon has a warning light, a speaker for delivering an audible signal, and a display for providing a written warning. A method for warning motorists of the presence of an oncoming locomotive object such as a train using the warning device is also provided.

As a way of illuminating a railroad intersection, U.S. Pat. No. 6,683,540 discloses a railroad crossing signal apparatus which utilizes a series of “signal head members.” The signal head members are permanently placed in the roadway within the path of traffic approaching a railroad track. The signal head members define a series of lights embedded in the pavement which are activated in response to a signal. The signal, in turn, is activated by an undefined signal or switch generated by the approach of a train. The device of the '540 patent requires that the pavement be graded or temporarily removed and that a plurality of lighting instruments and associated wiring be placed generally about grade level. Moreover, the lights may not successfully warn drivers of an oncoming train, but could be interpreted by drivers as simply a part of the highway lighting system.

Various signals and switches have been devised for activating warning systems. Many prior detection systems utilize the tracks themselves to convey information to a receiver down the track. In this respect, the tracks themselves become part of a circuit activated by pressure or other means. For instance, U.S. Pat. No. 3,715,669 discloses a receiver for a frequency modulated overlay track circuit wherein components such as relay capacitors and resistors are connected to the rail. Operation of the warning system depends upon the wheels of the train interrupting an electrically generated signal through the track by use of a shunt which blocks signals to a transmitter.

U.S. Pat. No. 4,369,942 provides a signal communication system which employs an electrically generated current through the track. A low voltage current initiates or induces a signal through insulated tracks to engage a rail crossing signal wave system.

The Background section of U.S. Pat. No. 6,830,224 describes various other through-track communication devices for activating a warning system. However, such warning systems may be subject to malicious or accidental short circuiting.

Other systems utilize cables to make electrical connections within a warning system. However, it has been found that the cables should preferably be buried to provide insulation from vandals and weather. Moreover, burying cables adds considerably to the cost of installation.

In an effort to reduce these contingencies, U.S. Pat. No. 3,758,775 disclosed a signaling system that utilizes a microwave transmitter for producing a beam of energy. The beam conveys information about the presence or absence of a train from a remote location on a railroad track to a receiver located adjacent a highway-railroad crossing. In response to a predetermined modulation characteristic of the microwave beam that signifies the presence of a train, the receiver enables an active motorist warning device. The transmitter is located ¼ to ½ mile from the receiver.

U.S. Pat. No. 5,735,492 employs a magnetometer to sense the presence of an oncoming train. However, this system still relies upon buried cable extending from the magnetometer to a control unit which operates a warning system. (See col. 5).

Where no warning system is in place, it is up to the train operator to monitor the track and determine if a vehicle or string of vehicles is crossing at each intersection. Unfortunately, by the time a train operator has visual contact with the crossing area, it is usually too late to stop the train. According to U.S. Pat. No. 5,787,369, it typically takes up to a mile for a train to slow from 60 mph to 10 mph.

Therefore, there is a need for a new railroad crossing warning system which may be installed at roadway-railroad intersections and which is inexpensive. Further, there is a need for such a system that may in one aspect support existing active barrier systems, or alternatively be free standing at remote intersections.

### SUMMARY OF THE INVENTION

A traffic crossing warning device is first provided. The device in one embodiment includes a beam transmitter for transmitting a substantially constant beam, and a beam sensor in electrical communication with a signal processor. In addition, the device includes a multimedia warning beacon, and a mounting device for supporting the beacon and the beam sensor. Preferably, the beam is an infrared beam transmitted by an IR transmitter. The beam is broken by the presence of a locomotive object such as a train, thereby actuating the warning beacon.

The multimedia warning beacon delivers a warning to motorists or pedestrians at an intersection in at least two ways. Preferably, the beacon has (1) at least one warning light, (2) a speaker for delivering an audible signal, and (3) a display for providing a text warning. The beacon is activated when the IR beam sensor senses that the infrared beam is not being received. The intersection may be a roadway-railway intersection, with the locomotive object being a train.

The multimedia warning beacon is mounted on a mounting device. The mounting device preferably includes a pole, and serves as a mechanism for mounting the IR beam sensor and the multimedia warning beacon adjacent a roadway-railway intersection at an elevated position. The multimedia warning beacon is positioned so that warning signals are visible/audible to motorists in a lane of traffic at an intersection to warn of the presence of an oncoming train. Further, the IR beam sensor is positioned so as to receive the beam of the infrared beam transmitter until beam reception is broken when a train intersects the path of the IR beam.

A method for warning of an oncoming locomotive object such as a train is also provided. In one embodiment, the method comprises the steps of providing a traffic crossing warning device, and installing a mounting device adjacent a roadway intersection. Where the object is a train, the intersection is a roadway-railway intersection. The traffic crossing warning device includes a beam transmitter for transmitting a constant beam, and a beam sensor in electrical communication with a signal processor. In addition, the device includes a multimedia warning beacon supported by the mounting device. Preferably, the warning device has at least one warning light, a speaker for directing an audible signal, and a display for providing a written warning. Preferably, the beam is an infrared beam transmitted by an IR transmitter.

The mounting device is provided for mounting the infrared beam sensor and the multimedia warning beacon. The multimedia warning beacon is again positioned such that the multimedia warning beacon is visible to motorists and/or pedestrians in a lane of traffic at an intersection so as to warn motorists of the presence of an oncoming train. Further, the IR beam sensor is positioned so as to receive the beam of the infrared beam transmitter until beam reception is broken when a train intersects the path of the IR beam.

### BRIEF DESCRIPTION OF THE DRAWINGS

So that the manner in which the above recited features of the present invention can be better understood, certain drawings and flowcharts are appended hereto. It is to be noted, however, that the appended artwork illustrates only selected embodiments of the inventions and are therefore not to be considered limiting of scope, for the inventions may admit to other equally effective embodiments and applications.

FIG. 1 is a perspective view of the railroad track warning device of the present invention, in one embodiment. The warning device is installed adjacent a roadway-railway intersection.

FIG. 2 is an enlarged view of a multimedia warning beacon.

FIG. 3 presents a schematic arrangement of the railroad track warning device of FIG. 1.

FIG. 4 presents an operational flow chart for the circuitry controlling the railroad track warning device, in one embodiment.

### DETAILED DESCRIPTION

Definitions

As used herein, the term “signal processor” refers to any electrical device capable of receiving a signal, and transmitting a new signal in response. The signals may be analog, digital, or a combination thereof. The processor may be controlled by software, or by hardware or firmware. Non-limiting examples of a signal processor include a relay (electro mechanical or solid state), a switch, a transducer, a motherboard, or a microprocessor.

As used herein, the term “motorist” refers to a driver or a passenger in a motorized vehicle. A motorized vehicle may be a car, a van, a motorcycle, a truck, or other mechanized, over-the-road transport mechanism.

The term “train” may be a steam engine, a coal car, a subway, a metro transport train, a rail car pulled by an engine, or any other locomotive device that rides on a rail.

The term “locomotive object” means any object capable of self locomotion. Such objects include trains, trucks, light rail cars, subways and cars.

The term “beam” means any beam that is transmitted at a substantially continuous basis. Non-limiting examples include infrared or IR beams, and laser beams.

Description of Specific Embodiments

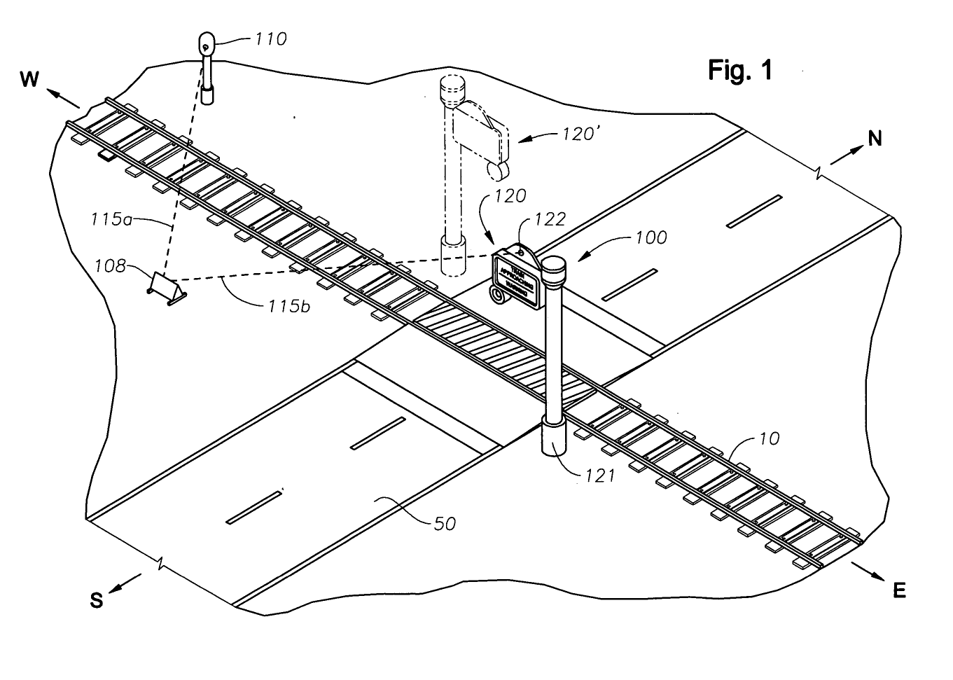

FIG. 1 presents a perspective view of the traffic warning device 100 of the present invention, in one embodiment. The device 100 is shown installed adjacent a roadway 50 and an intersecting railroad track 10, or “railway.”. Thus, in this embodiment the traffic warning device is a railroad track warning device which serves to warn as to the presence of an oncoming train (not shown). However, it is understood that the device 100 could be used to sense the presence of other oncoming locomotive objects such as light rails or trucks at any roadway intersection. For instance, the device 100 could warn of an oncoming truck at an intersection having an extended blind spot.

In FIG. 1, the roadway 50 and the railway 10 interest to form a roadway-railway intersection or crossing. The roadway 50 extends in opposing directions from the railway 10. This permits motorists to traverse the road and to cross the railroad track 10 in either direction. The view of FIG. 1 shows the top portion of the roadway 50 as being in the “N” direction, or north, and the bottom portion of the roadway 50 as being in the “S” direction, or south. Of course, this roadway is merely illustrative.

The railway 10 also extends in opposing directions. The view of FIG. 1 shows the left portion of the railway 10 as being in the “W” direction, or west, and the right portion of the railway 10 as being in the “E” direction, or east, both being away from the roadway 50. This railway 10 too is merely illustrative.

The device 100 comprises two primary components—a beam transmitter 110 and a multimedia warning beacon 120. Each component 110, 120 is positioned in proximity to the railway 10. The exemplary device 100 is set up to detect the presence of a train approaching from the west. Of course, the device 100 could be set up to monitor a train (or other locomotive object) approaching from the east. Alternatively, two separate devices 100 employing two separate beam transmitters 110 may be used to detect the presence of trains approaching from both directions.

First, the beam transmitter 110 transmits a substantially continuous beam. The beam is indicated at 115. Preferably, the beam transmitter transmits an infrared beam, though other beams such as laser beams may be employed. In the arrangement of FIG. 1, the beam 115 is split into two beams—115a and 115b. Beam 115a is reflected off of a mirror 108, which in turn reflects beam 115b to the multimedia warning beacon 120. This reflected beam arrangement allows the beam 115 to intersect the path of railway cars (not shown) at a greater distance from the multimedia warning beacon 120, thereby increasing the warning time. However, it is understood that an arrangement could be made wherein the beam 115 is a direct beam sent from the beam transmitter 110 directly to the multimedia warning beacon 120.

The beam 115 is directed to a beam sensor 122. In the arrangement of FIG. 1, the beam sensor 122 is integral to the multimedia warning beacon 120. Alternatively, the beam sensor 122 may be remote from the warning beacon 120, such as at mirror 108. In either instance, the beam sensor 122 serves as an IR receiver.

The infrared beam transmitter 110 may be any transmitter which continuously transmits an infrared beam. One non-limiting example of a transmitter is an infrared light emitting diode. Similarly, the beam sensor 122 may be any receiver capable of detecting the presence of the IR beam 115. It is preferred that the beam 115 intersect the railroad cars at an angle less than 90 degrees; otherwise, the beam sensor 122 might be re-energized when the beam cross the track between passing cars.

Point Six Wireless of Lexington, Ky. manufactures a “Point Six IR Point Sensor.” This is a battery operated infrared beam interruption sensor with a 418 MHz radio transmitter. The sensor consists of two parts: the IR transmitter and the IR receiver. The IR receiver has an integrated 6-digit LCD counter and a radio transmitter for truly wireless installation and operation. The IR transmitter produces 16 pulses of IR each second across a distance of up to 60 feet in low power mode, and up 100 feet in high power mode.

The user can select the power mode by pushbutton on the Point Six IR transmitter. The IR transmitter flashes 16 pulses of high intensity IR each second. The nature of these IR pulses is such that the IR receiver can distinguish them from any other source of IR. This characteristic allows the IR sensor to operate in almost any environment without interference from ambient lighting.

The Point Six IR Point Sensor is designed to require very little energy. In this respect, an internal 3.6 Volt Lithium battery will operate the IR receiver for up to 6.5 years in unbroken beam mode, and 3 years in normal operation. The IR transmitter can operate on a single 3.6 Volt internal Lithium battery for 1 year in low power mode and 4 months in high power mode. High power mode is preferred in order to extend the range, that is the distance between the IR transmitter 110 and the receiver 122.

The IR transmitter 110 is indicated in FIG. 1 as being positioned atop a pole. The Point Six transmitter comes with an integrated mounting flange for securing to the pole. An optional flush-mount wall box kit is also provided.

In order to install the device 100, the beam 115 must be aligned with the receiver or beam sensor 122. The Point Six transmitter can be placed in a “setup mode” by pushing a button for a short time of one to four seconds. The receiver 122 comes in the setup mode. For a period of two minutes, an LED on the receiver 122 will glow to indicate the reception of the IR beam from the transmitter. After two minutes of uninterrupted beam, the receiver 122 will exit setup mode and go into online mode. In online mode, the LED on the front of the receiver 122 will flash briefly each time the IR beam is interrupted.

An LCD counter is provided in the Point Six receiver 122, which will count each beam interruption. In addition, an internal 24-bit counter will count the beam-interruption time. The LCD counter and the internal 24-bit counters will perform a counter reset each time the push button on the IR receiver 122 is pushed and held for more than 4 seconds. Counter reset is best performed after the receiver 122 and transmitter 110 have been set up for online mode operation using setup mode.

The Point Six IR system is merely exemplary; other IR systems may be utilized. In addition, other means for providing power to an IR transmitter 110 besides a battery may be employed. Other power sources include solar power systems and conventional line power.

It is noted that in the view of FIG. 1 the warning beacon 120 is on the south side of the track 10. However, the beacon 120 could have been placed on the north side of the track 10. In either event, the beacon 120 and accompanying beam transmitter 110 are set up to warn motorists as to trains approaching from the west. In this respect, when a train approaches from the west, the beam 115 is interrupted for an extended period of time. This, in turn, causes the beam sensor 122 to send a signal to components of the multimedia warning beacon 120, as will be described further below.

Some railroad tracks are set up such that rail traffic may travel in either direction. In this arrangement, it is preferred that a second warning device 100 be set up to monitor rail traffic approaching from the east. In the arrangement of FIG. 1, a second warning beacon 120 is shown in phantom. This beacon 120′ is erected on the north side of the track 10. It is understood that the second beacon 120′ operates with a separate beam transmitter (not shown). However, it is within the scope of the present invention to include a second beam sensor 122 within the multimedia warning beacon 120 which receives an IR beam from a transmitter (not shown) on the east side of the roadway 50. In this way, railroad traffic may be monitored and warned of as it approaches from either west of or east of the road 50.

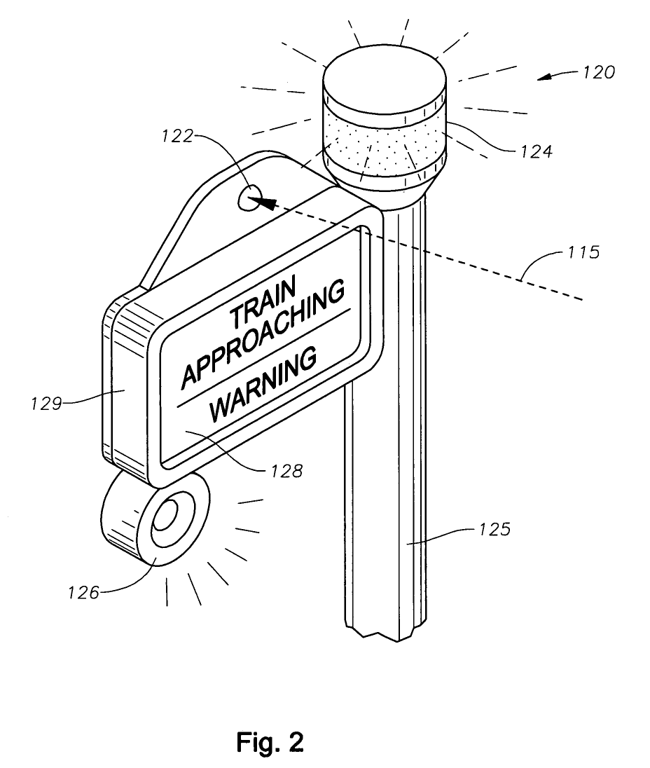

FIG. 2 is an enlarged view of the multimedia warning beacon 120 of FIG. 1. Various components of the beacon 120 are more clearly seen. Those components include not only the beam sensor 122, but also various warning media including a light 124, a speaker 126 and a text screen 128. Each of these media is supported by a housing 129.

The illustrative light 124 is posted atop the beacon 120. It may be of any type of light designed to be seen by motorists approaching the railway 10. Receipt of a “no beam” signal from the beam sensor 122 activates the light 124. In one instance the light is a plurality of red lights that sequentially flash when a train begins to approach the roadway 50. However, other arrangements and positions for a light may be provided.

The illustrative speaker 126 is situated below the housing 129, and delivers an audible message or alert to motorists approaching the railway 10. In one instance the speaker 126 delivers a pre-recorded verbal message which says: “Warning, Train Approaching.” In another embodiment, the speaker 126 delivers a siren or warning noise such as delivered by a car alarm. The speaker 126 delivers the warning at sufficient volume to be heard by a motorist in an approaching vehicle. That means that the volume must be loud enough to be heard over the running engine and the approaching sound of the train. In one instance, the speaker volume has a range from 80 to 120 decibels. Receipt of a “no beam” signal from the beam sensor 122 activates the speaker 126 to emit a high decibel warning sound or message.

The illustrative text message 128 is provided on a screen presented on a face of the housing 129. In one instance the text message 128 reads: “Train Approaching: Warning.” In one embodiment, the message 128 flashes with yellow letters illuminated by light emitting diodes. The screen delivers the message 128 at sufficient font size to be seen by a motorist in a vehicle from a distance of up to 50 feet and, more preferably, 100 feet. Receipt of a “no beam” signal from the beam sensor 122 activates the text message 128. In one aspect, each side of the beacon 120 includes the text message so that the message is seen by motorists approaching from either direction.

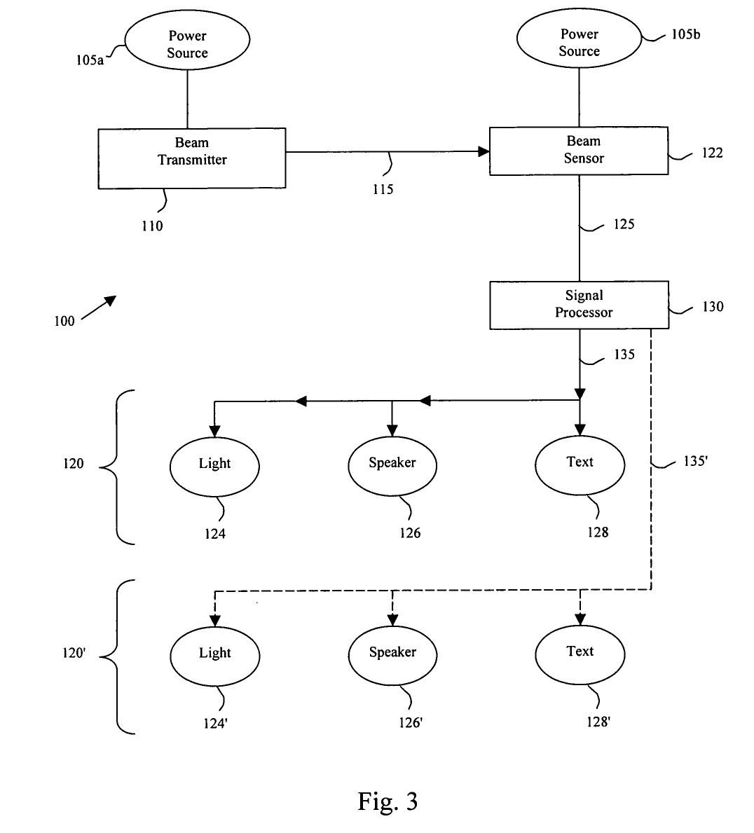

The warning device 100 includes a signal processor for performing various control and signal communication tasks. FIG. 3 presents a schematic arrangement of the railroad track warning device 100 of FIG. 1. The signal processor is shown schematically at 130. The signal processor 130 enables the warning media 124, 126, 128 to be activated in response to a “no-beam” signal from the beam sensor 122.

The signal processor 150 may be any device as defined above. For instance, the signal processor 150 may be a simple analog switch or relay. At the other end of complexity, the signal processor 150 may be a handheld, element-tolerant computer such as an RHC1000 having a 320×240 LCD screen. This military-grade computer is available from Paravant of Melbourne, Fla.

Preferably, the signal processor 130 is a micro-controller which detects the signal from the IR beam sensor 122 continuously or multiple times each minute. If the IR beam sensor 122 no longer receives or senses the infrared beam 115 from the transmitter 110, the micro-controller 130 detects this. The micro-controller 130 rechecks the presence of a signal after or during a designated period of time, such as two seconds. In this way, a false alarm caused by an animal or railway pedestrian does not trigger the multimedia warnings 124, 126, 128.

If the micro-controller 130 again detects a signal indicating the absence of an IR beam from the beam sensor 122, then a new signal is sent by the micro-controller 130 to various components 124, 126, 128 of the multimedia warning beacon 110. This signal step is shown at 135.

The warning beacon 120 and its components may be powered through pre-charged or rechargeable batteries. The batteries may be housed within the housing 129. Where rechargeable batteries are used, recharging of the batteries (not shown) may be accomplished by means of a solar panel array (also not shown) positioned atop an adjacent pole. Use of solar panels to recharge the beacon 120 is desirable when the device 100 is to be deployed at crossings located in rural areas where a source of electrical line power is not readily available.

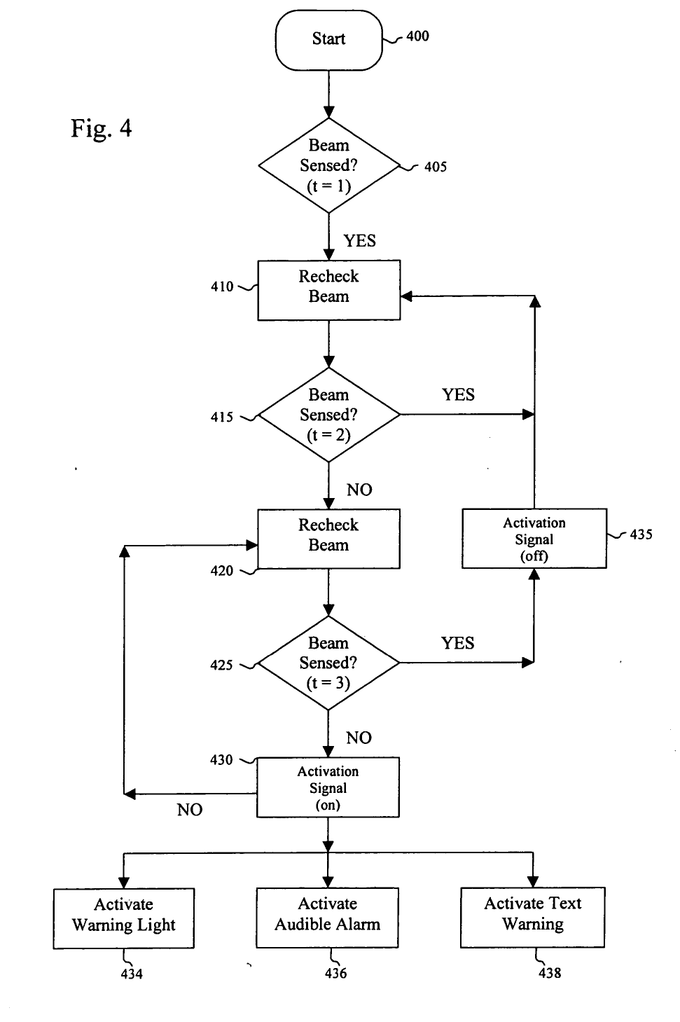

FIG. 4 presents an operational flow chart for the circuitry controlling the railroad track warning device 100, in one embodiment. More specifically, a control algorithm operated by a microprocessor is provided. Those of ordinary skill in the art will understand that a microprocessor typically includes a communications bus which electronically and communicatively connects various elements, including the processor element, a random access memory (RAM), a read only memory (ROM), a communication module and an input/output module (all not specifically shown).

The communication module is electronically and communicatively coupled to the beam sensor 122. The input/output module converts incoming and outgoing external analog signals to and from internal digital signals, and is operatively and electronically coupled to the warning components 124, 126, 128. The communication module receives the beam sensor signal and passes an activation signal on to the warning components 124, 126, 128. This is described in additional detail below.

The ROM stores program instructions for operating the components 124, 126, 128 and for interpreting the signal received from the beam sensor 122. The ROM also stores any constant values needed for comparison. The RAM stores variables that change such as the status of the clock (discussed in connection with FIG. 4) and the status of the sensor 122.

The algorithm is activated after the beam 115 is directed from the IR transmitter 110 to the beam sensor 122. The start of the cycle is indicated at block 400. Initial confirmation is provided that the beam 115 is sensed, and a clock registers this at t=1. This is indicated at block 405.

After a designated period or unit of time “t”, the beam 115 is rechecked. Block 410 indicates a setting of the clock at t=2. The beam 115 is then rechecked by the beam sensor 122. This step is indicated at block 415. If the presence of the beam 115 is confirmed, the micro-controller redirects the clock to be reset in accordance with block 410, and the beam 115 is again sensed through block 415. This sequence is repeated for as long as the beam 115 is sensed. In one aspect, the sequence is repeated every two seconds.

If the infrared beam 115 becomes blocked by an object, then the beam 115 is not sensed by the beam sensor 122. In this instance, the clock is again reset as indicated in block 420. However, to avoid a false alarm and the unnecessary activation of the warning beacon 120, the beam 115 is again sensed after a designated time period indicated as “t=3”. Where the locomotive object to be sensed is a long object such as a train, then time “3” is also preferably a period of about two seconds. If the beam 122 was blocked due to an animal or pedestrian or other temporary condition, then the beam 115 may again be sensed. Thus, block 425 indicates that the beam 115 is to be rechecked. If the beam 115 is now sensed, then the clock is reset to t=2 per block 410. The activation signal for activating the warning beacon 120 and its components 124, 126, 128 remain off.

If the beam 115 remains unsensed in block 425, then it is assumed that a locomotive object such as a train is approaching and the binary (on or off) activation signal is turned on. This is indicated in block 430. The activation signal turns on the beacon components, such as components 124, 126, 128. However, the circuitry will continue to recheck the beam by resetting the clock at block 420 and rechecking the beam at block 425. Eventually the train will pass and the beam 115 will again be detected. In this event, the activation signal is turned off as indicated at block 435.

The algorithm of FIG. 4 cycles iteratively from beam check 410, completing each cycle forever. It is noted that the control algorithm shown in FIG. 4 is merely illustrative; other ways for executing the steps sensing the beam 115 and then activating the warning components 124, 126, 128 may be employed.

It is noted that a shorter time period may be used for cycled sensing where the locomotive object to be sensed is a truck or shorter object. This would be applicable to a roadway intersection without a train crossing. In this case, there would be no recheck as shown in step 420; instead, the activation signal of step 430 would take place, and the signal would be rechecked in accordance with step 410.

It is also noted here that it is within the scope of this invention to place two beacons such as beacons 120, 120′ shown in FIG. 1 in electrical communication with each other. In this way, when one beacon, e.g., beacon 120, is activated, the other beacon, e.g., beacon 120′ is also automatically activated. The flow chart of FIG. 3 shows that when the signal processor 130 of beacon 120 is activated, it sends a signal in step 135 to warning components 124, 126, 128. In addition, the signal processor 130 may optionally send a signal 135′ to warning components 124′, 126′, 128′ of beacon 120′.

A method for warning of an oncoming train is also provided. The method is disclosed in the context of the embodiment of the warning device 100 illustrated by FIGS. 1, 2 and 3. However, the method may be performed through the use of other warning device embodiments. In one aspect, the method first comprises the step of providing a railroad crossing warning device. The device includes a beam transmitter such as an IR transmitter for transmitting a constant beam, a beam sensor in electrical communication with a signal processor, and a multimedia warning beacon. The beacon is activated when the beam sensor senses that the IR (or other) beam is not being received for a predetermined period of time. The warning beacon has any of at least one (and preferably all three) of a warning light, a speaker for directing an audible signal, and a display for providing a written warning.

The method also includes the step of installing a mounting device for mounting an IR beam sensor and the multimedia warning beacon. The mounting device is installed in such a manner that (a) the multimedia warning device is visible to a lane of traffic at a roadway-railroad intersection to warn motorists of the presence of an oncoming train, and (b) the IR beam sensor receives the beam of the infrared beam transmitter until beam reception is broken when a train intersects the path of the IR beam.

It should again be understood that the disclosed embodiments are merely exemplary of the inventions, which may be embodied in various forms. Therefore, the details disclosed herein are not to be interpreted as limiting, but merely as the basis for the claims and as a basis for teaching one skilled in the art how to make and/or use the invention.

I claim:

1. A traffic crossing warning device, comprising:
a beam transmitter for transmitting a substantially constant beam;
a beam sensor in electrical communication with a signal processor for sensing the beam;
a multimedia warning beacon activated when the beam sensor senses that the beam is not being received for a predetermined period of time, the warning beacon having at least two of:
at least one warning light,
a speaker for delivering an audible signal, and
a display for providing a text warning; and
a mounting device for mounting the beam sensor and the multimedia warning beacon adjacent an intersection at an elevated position such that the multimedia warning beacon may be visible to a lane of traffic at the intersection to warn motorists or pedestrians of the presence of an oncoming locomotive object.

2. The traffic crossing warning device of claim 1, wherein:
the intersection is a railway-roadway intersection; and
the locomotive object is a train.

3. The traffic crossing warning device of claim 1, wherein the signal processor comprises at least one of a switch, a relay, and a microprocessor.

4. The traffic crossing warning device of claim 1, wherein the signal processor comprises a handheld computer.

5. The traffic crossing warning device of claim 1, wherein the mounting device comprises a pole for supporting the beam sensor and the multimedia warning beacon at an elevated position above a railroad track.

6. The traffic crossing warning device of claim 1, wherein the beam is an infrared beam.

7. The traffic crossing warning device of claim 6, wherein the beam delivered from the signal transmitter to the beam sensor is a reflected beam.

8. The traffic crossing warning device of claim 6, wherein the beam delivered from the signal transmitter to the beam sensor is a direct beam.

9. The traffic crossing warning device of claim 1, wherein the text warning is seen on opposing sides of the warning beacon.

10. The traffic crossing warning device of claim 1, wherein the warning beacon further comprises a housing, and the housing supports the beam sensor.

11. The traffic crossing warning device of claim 1, wherein the beam sensor is remote from the warning beacon.

12. A method for warning of an oncoming locomotive object, comprising the steps of:
providing a traffic crossing warning device, the device comprising:
a beam transmitter for transmitting a substantially constant beam,
a beam sensor in electrical communication with a signal processor for sensing the beam,
a multimedia warning beacon activated when the beam sensor senses that the beam is not being received for a predetermined period of time, the warning beacon having at least two of (1) at least one warning light, (2) a speaker for directing an audible signal, and (3) a display for providing a written warning; and
installing a mounting device for mounting the beam sensor and the multimedia warning beacon such that (a) the multimedia warning device is visible to a lane of traffic at a roadway intersection to warn motorists or pedestrians of the presence of an oncoming locomotive object, and (b) the beam sensor is positioned so as to receive the beam of the beam transmitter until beam reception is broken when a locomotive object intersects the path of the beam.

13. The traffic crossing warning device of claim 12, wherein:
the roadway intersection is a roadway-railroad intersection; and
the locomotive object is a train.

14. The traffic crossing warning device of claim 13, wherein the signal processor comprises a microprocessor.

15. The traffic crossing warning device of claim 14, wherein the mounting device comprises a pole for supporting the beam sensor and the multimedia warning beacon at an elevated position above a railroad track.

16. The traffic crossing warning device of claim 12, wherein:
the beam is an infrared beam; and
the beam transmitter is an infrared beam transmitter.

17. The traffic crossing warning device of claim 16, wherein the IR beam delivered from the signal transmitter to the beam sensor is a reflected beam.

18. The traffic crossing warning device of claim 16, wherein the IR beam delivered from the signal transmitter to the beam sensor is a direct beam.

19. The traffic crossing warning device of claim 12, wherein the text warning is seen on opposing sides of the warning beacon.

20. The traffic crossing warning device of claim 12, wherein the warning beacon further comprises a housing, and the housing supports the beam sensor.
